(19) United States
(12) Patent Application Publication
(10) Pub. No.: US 2009/0044144 A1
(43) Pub. Date: Feb. 12, 2009

(54) Methods And Apparatus For Sharing User Interface Widget Annotations

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/834,271

(22) Filed: Aug. 6, 2007

(51) Int. Cl. G06F 3/048

(52) U.S. Cl. 715/804

(57) ABSTRACT

Methods and apparatus are disclosed for sharing user interface widget annotations. According to an exemplary embodiment, a method is described for sharing user interface widget annotations including determining an attribute of a first user interface widget of a first application. Annotation information for the first user interface widget is received and the annotation information associated with the first user interface widget using the attribute. Information describing the association of the annotation information and the first user interface widget is shared with a second application, different from the first application. The shared information enables the second application to present the annotation information in association with a second user interface widget of the second application.

### RELATED APPLICATIONS

This application is related to U.S. patent application Ser. No. ______, titled “METHODS AND APPARATUS FOR USING ANNOTATED USER INTERFACE WIDGETS IN SEARCH OPERATIONS” (Attorney Docket No. I464/US), filed on even date herewith and owned by the owner of this application, the entire disclosure of which is here incorporated by reference.

### BACKGROUND

While much about computer user interfaces has become standardized, at least, on a given operating system, today's computer user interfaces can still be difficult to navigate and rather inflexible to use. One attempt to address these shortcomings has been through the use of user-customizable user interfaces. With such arrangements, users are allowed to change the skin/scheme of an application's or system's user interface, or may be able to change one or more of the interface's individual attributes. For example, customizable arrangements can allow users to hide or unhide various user interface components (or widgets or controls) as well as to control what types of data are included in such widgets, such as menu and list items. Conventional customizable interfaces also allow users to change the colors and/or fonts of the interface.

As can be seen from the examples provided above, conventional customizable user interfaces provide functionality mainly for customizing the appearance of application or system user interfaces. To some extent, these interfaces allow the user to change the organization of the user interface (e.g., by changing which menu or list items appear in a corresponding menu or list widget). But conventional customizable user interfaces still do little to help a user understand the meaning or purpose of a particular widget, such as a button, checkbox, panel, or other user interface widget in the context of its owning application or system.

The number of tagging sites present on the Internet has grown significantly in recent years. Tags are short, free form annotations or labels used to describe items in an area. They allow people to remember and organize information such as email, web sites, photos, blogs, research papers, and the like. Popular tagging sites today include, among others, DEL.ICIO.US™, for tagging and sharing bookmarks, and FLICKR™, for tagging and sharing digital photos. Tagging sites or systems are a powerful resource for driving social navigation, helping people to share and discover new information contributed by other community members. An important characteristic of tagging systems that promote social navigation is their vocabulary—the set of tags used by members of the community. Instead of imposing controlled vocabularies or categories on members, tagging systems' vocabularies emerge organically from the tags chosen by individual members, and thus can be more meaningful.

### SUMMARY

Accordingly, methods and apparatus are disclosed for sharing user interface widget annotations. According to an exemplary embodiment, a method is described for sharing user interface widget annotations including determining an attribute of a first user interface widget of a first application. Annotation information for the first user interface widget is received and the annotation information associated with the first user interface widget using the attribute. Information describing the association of the annotation information and the first user interface widget is shared with a second application, different from the first application. The shared information enables the second application to present the annotation information in association with a second user interface widget of the second application.

According to another exemplary embodiment, a method is described for sharing user interface widget annotations including receiving information including an attribute of a first user interface widget of a first application and annotation information associated with the first user interface widget via the attribute. At least a portion of the annotation information is associated with a second user interface widget of a second application, different from the first application. The at least a portion of the annotation information associated with the second user interface widget of the second application is presented.

According to yet another exemplary embodiment, a device is described for sharing user interface widget annotations including an annotation event monitor component configured to determine an attribute of a first user interface widget of a first application included on the device. The device includes an annotation user interface component configured to receive annotation information for the first user interface widget. A search/index manager component is included in the device and is configured to associate the annotation information with the first user interface widget using the attribute. The device further includes a share manager component configured to share information describing the association of the annotation information and the first user interface widget with a second application, different from the first application. The shared information enables the second application to present the annotation information in association with a second user interface widget of the second application.

According to still another exemplary embodiment, a server is described for sharing user interface widget annotations including an annotation event monitor component configured to receive information including an attribute of a first user interface widget of a first application and annotation information associated with the first user interface widget via the attribute. The server includes a search/index manager component configured to associate at least a portion of the annotation information with a second user interface widget of a second application, different from the first application. The server also includes a share manager component configured to share information describing the association of the annotation information and the first user interface widget with a second application, different from the first application. The shared information enabling the second application to present the annotation information in association with a second user interface widget of the second application.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for sharing user interface widget annotations, according to an exemplary embodiment;

FIG. 2 illustrates a client-based device for sharing user interface widget annotations and for using annotated user interface widgets in search operations, according to an exemplary embodiment;

FIG. 3A illustrates a user interface for sharing user interface widget annotations, according to an exemplary embodiment;

FIG. 3B illustrates a user interface for using annotated user interface widgets in search operations, according to an exemplary embodiment;

FIG. 4 illustrates arrangement of networked devices for sharing user interface widget annotations and for using annotated user interface widgets in search operations, according to an exemplary embodiment;

FIG. 5 illustrates a server-based system for sharing user interface widget annotations and for using annotated user interface widgets in search operations, according to an exemplary embodiment;

FIG. 6 is a flowchart illustrating another method for sharing user interface widget annotations, according to an exemplary embodiment; and

FIG. 7 is a flowchart illustrating a method for using annotated user interface widgets in search operations.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

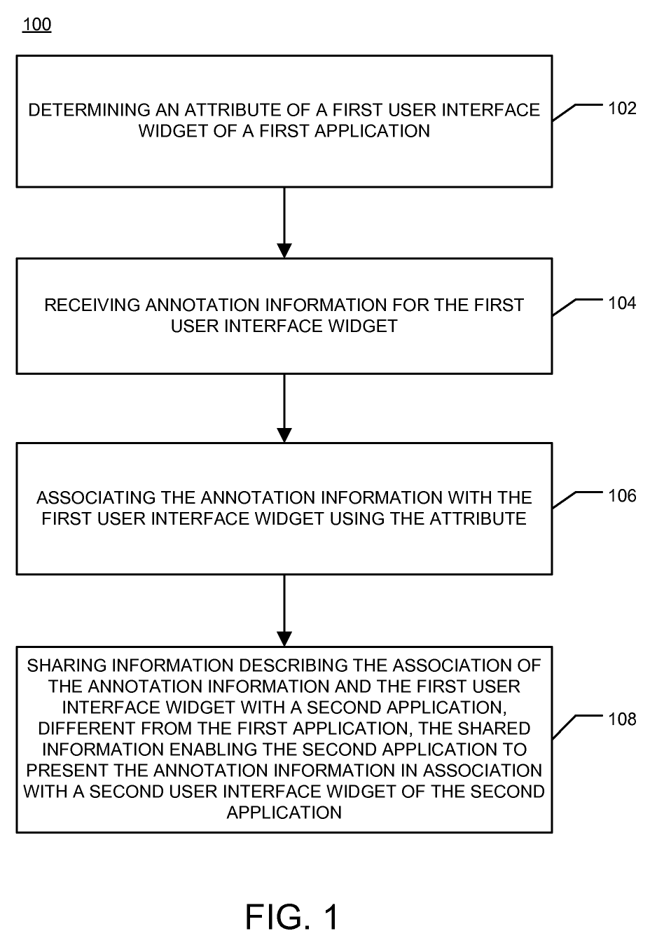

FIG. 1 is a flowchart illustrating an exemplary method for sharing user interface widget annotations. In computer programming and in the context used here, a widget is a component of a graphical user interface (or GUI) for a program or application that a user can use to interact with the program or application. Widgets are sometimes described as being virtual to distinguish them from their physical counterparts, e.g., virtual buttons that can be selected (or “clicked on”) with a mouse cursor, versus buttons that can be physically activated (e.g., with a press of a finger). Widgets are often packaged together in widget toolkits. Programmers often use such widget toolkits to build GUIs. Examples (a non-exhaustive list) of widgets include buttons, check boxes, list boxes, drop-down lists, radio buttons, menus, toolbars, ribbons, combo boxes, icons, tree views, grid views, scrollbars, text boxes, labels, tooltips, balloon help, status bars, progress bars, windows, dialogs, panes, panels, palette windows, and the like.

The term widget, as used to here, can also include so-called “desktop widgets,” such the widgets made available via YAHOO! Widgets, supported by the Konfabulator widget engine, APPLE's Dashboard, and MICROSOFT's Active Desktop. Desktop widgets are built using the underlying windowing and graphics subsystems provided by the operating environment of the host device, thus desktop widgets are implemented using GUI widgets, such as those described above. Another type of widget within the scope of this disclosure is a Web-based widget, such as HyperText Markup Language (HTML) presentable elements, ADOBE FLASH-based presentable entities, and the like. Persons skilled in the art will understand that the types of widgets described above are merely exemplary, and other types of widgets having similar functionality are within of the scope of the subject matter described here.

### Sharing User Interface Widget Annotations

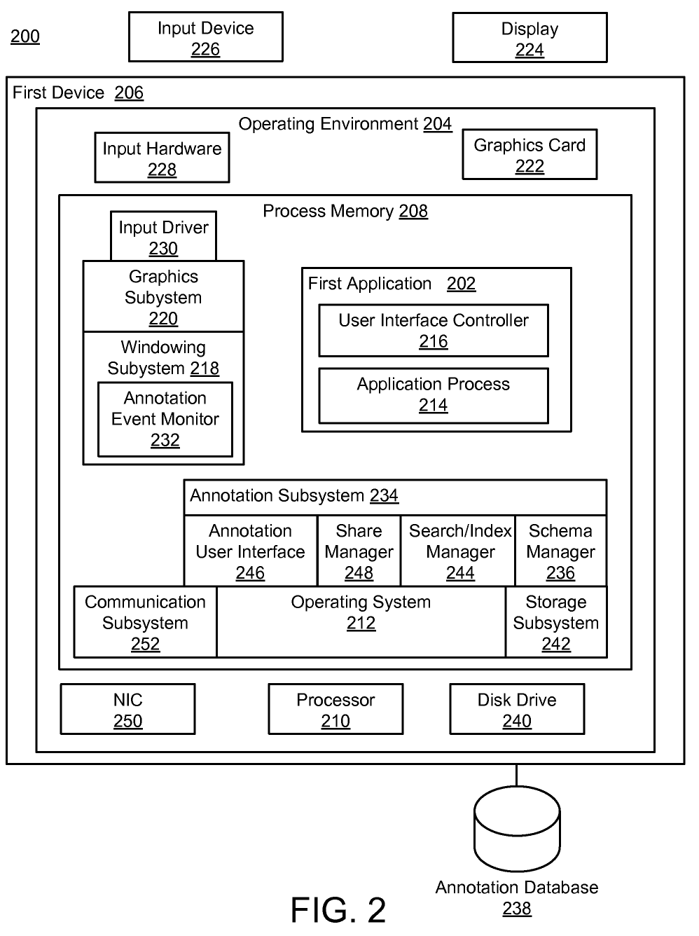

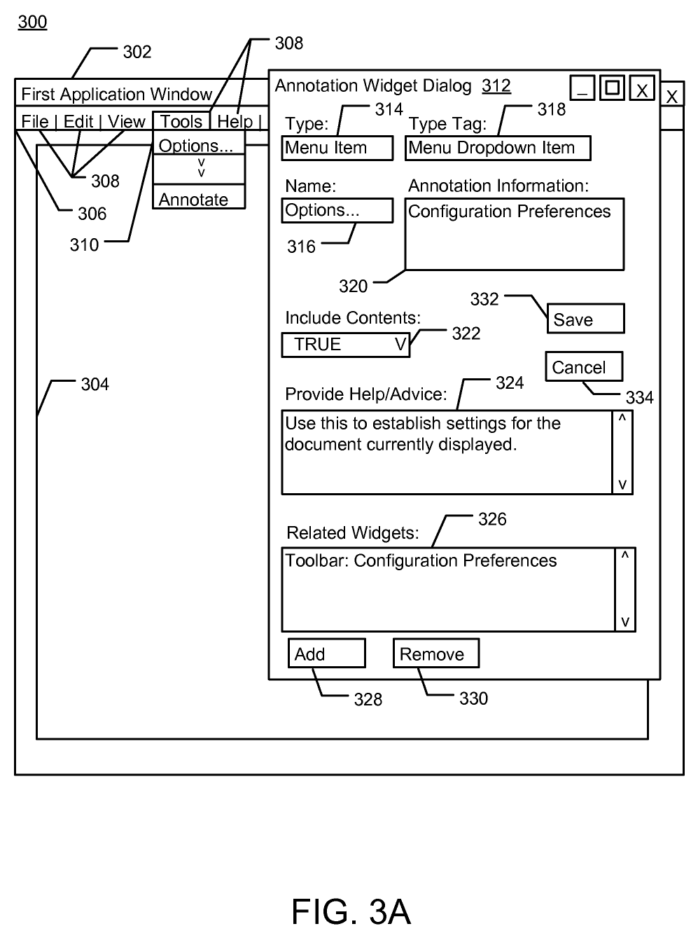

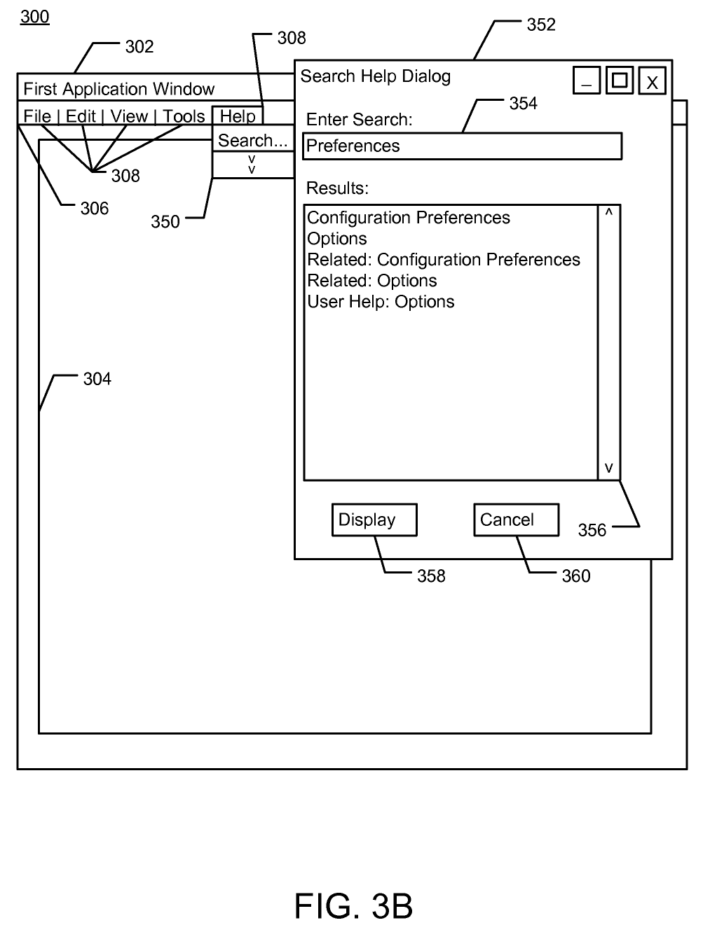

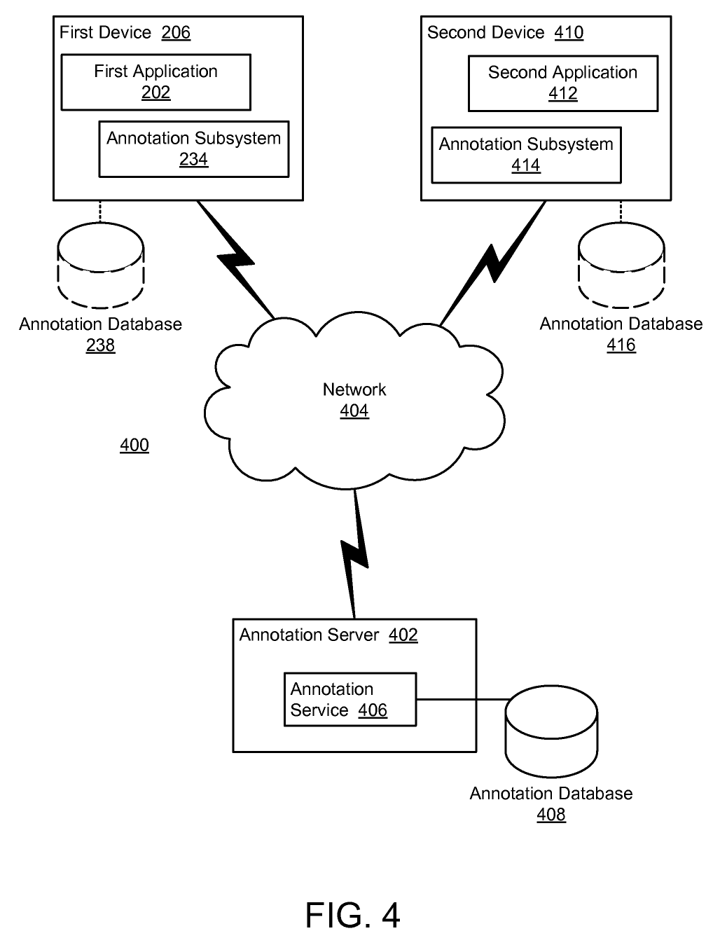

The method illustrated in the flow diagram of FIG. 1 can be carried out using the exemplary device and user interface depicted in FIGS. 2 and 3, respectively, portions of which are referenced below for illustration purposes. The arrangement 200 depicted in FIG. 2 includes a first application (e.g., a software program) 202 operating in an operating environment 204 of a first device 206. As shown in FIG. 4, the first device 206 can be coupled to other devices, e.g., a second device 410, and to a server 402 via a network 404, and is thus sometimes referred to here as a client device 206. Nevertheless, persons skilled in the art will understand that the first device 206 need not be coupled to a server device, such as the server 402, to be considered within the scope of the subject matter described here.

At least a portion of the first application 202 operating in the first device 206 is loaded into a processor memory 208 included in the operating environment 204. This arrangement allows an instruction and/or a data entity associated with the application 202 to be accessed and processed by a processor 210 included in the first device 206. As is typical of many application processes, the application 202 during operation accesses device resources managed by an operating system 212. The application 202 includes at least one application process 214 embodying the logic of the application 202, and a user interface controller 216 for enabling user interaction via a user interface, such as the user interface 300 shown in FIG. 3A. The user interface 300 depicted in FIG. 3A illustrates an exemplary user interface associated with the first application 202 operating in the first device 206 depicted both in FIGS. 2 and 4.

Returning to the arrangement of FIG. 2, the user interface controller 216 is configured to present the user interface 300 using a windowing subsystem 218. The windowing subsystem 218 is configured to interoperate with a graphics subsystem 220, both of which are included within the operating environment 204. The windowing subsystem 218 is configured to present a variety of widgets types, such as those described above. The windowing subsystem 218, using drawing capabilities of the graphics subsystem 220, creates representations of widgets in a display buffer (not shown) accessible to a graphics card 222. The graphics card 222 is operatively coupled to a display device 224 configured to present the contents of the display buffer.

The exemplary user interface shown in FIG. 3A includes a first application window widget 302 having a pane widget 304 for interacting with the first application 202. The pane widget 304 can include zero or more output widgets (zero widgets for an input-only pane) and zero or more input widgets (zero widgets for an output-only pane) for receiving user input in association with an input device 226, such as a mouse or a keyboard. The exemplary first application window widget 302 of FIG. 3A includes a toolbar widget 306 presenting a collection of toolbar menu widgets 308, such as a “File” menu widget, an “Edit” menu widget, a “View” menu widget, a “Tools” menu widget, and a “Help” menu widget, as shown (collectively, elements 308). The “Tools” menu widget is shown to be expanded in the figure, and includes an “Options . . . ” menu item widget 310. For illustration purposes, the “Options . . . ” menu item widget 310 will be used here as an example of the first user interface widget that is to be annotated.

Input events generated by the input device 226 are received by an input hardware component 228 compatible with the input device 226. The input hardware component 228 provides input event information to an input driver component 230 configured to process input events. It should be understood that the functionality of the input hardware component 228 and input driver component 230 can be separated, as shown, or can be combined. The input event information is provided to the windowing subsystem 218 via the operating system 212. The windowing subsystem 218 associates the input event information with a widget presented by the windowing subsystem 218, such as the widgets in the user interface. Input event information associated with a widget of the user interface is made available to the user interface controller 216 for processing by the first application 202, in some arrangements, and/or is automatically processed by the windowing subsystem 218 in other arrangements. For example, if a mouse click event is generated by the input device 226 when the windowing subsystem 218 presents a mouse pointer over the “Tools” menu widget 308, at least a portion of the menu item widgets included with the “Tools” menu widget 308, such as the “Options . . . ” menu item widget 310, are presented as directed by the user interface controller 216 via its instructions and/or configuration data provided to the windowing subsystem 218.

In a first block 102 of the exemplary method depicted in FIG. 1 an attribute of a first user interface widget of a first application is determined. For example, means for determining the attribute of the first user interface widget of the first application can include an annotation event monitor component 232. As shown in FIG. 2, the annotation event monitor component 232 can be included in the windowing subsystem 218 for receiving an annotation input event. The annotation input event includes an identifier of a widget to be annotated. In one embodiment, a specific type of input event generated via the input device 226 is designated as the annotation input event. When determined by the annotation event monitor component 232, the occurrence of the annotation input event can be used to cause a presentation of an annotation user interface component widget for receiving annotation information.

For example, a right mouse click can trigger the display of a context menu widget (not shown) as will be understood by the person of ordinary skill in the art. Such a context menu widget can include a designated menu item widget (e.g., “Annotate”) that, when activated, causes the annotation user interface component widget for receiving annotation information for a widget associated with the context menu widget being presented to be displayed. The annotation widget dialog 312 shown in FIG. 3A is an example of an annotation user interface component widget for receiving such annotation information. Alternatively, the widget to be annotated itself could include a control that, when activated, causes the annotation user interface component widget to be presented. For example, the expanded “Tools” menu widget 308 shown in FIG. 3A include an “Annotate” menu item widget for causing the annotation user interface component widget to be presented. Other examples of input events that can be designated to indicate an annotation input event include a gesture over a widget, such as a clockwise pointer movement input, a designated key or key sequence, and/or a tap pattern on a touchpad. A user can be allowed to define the input event to associate with annotation specification or an application can define the input event.

In an alternative embodiment, the annotation event monitor component 232 can be included in an annotation subsystem 234 rather than integrating the monitor component 232 with the windowing subsystem 218. In another arrangement, the annotation event monitor component can be included in an application (not shown), such as the first application 202, or provided as a shared utility for a family of applications. Regardless of the arrangement of the annotation event monitor component, when an annotation input event is received, the annotation subsystem 234 is enabled for receiving annotation information associated with a corresponding widget. Persons skilled in the art will understand that other arrangements of the annotation event monitor component 232 with components of the operating environment 204 are within the scope of the subject matter described here. Analogously, those skilled in the art will understand that the annotation subsystem 234 and/or some or all of its components can be included in an application, a shared library, such as a dynamic link library (or DLL), for a family of applications, provided as part of an operating environment, as depicted in FIG. 2, or included in a subsystem of an operation environment, such as a windowing subsystem 234. Further, the annotation event monitor component 232 and/or the annotation subsystem 234 can be hosted, at least in part, by a remote device, as will be described in greater detail below.

As described above, the attribute of the first user interface widget can be determined by receiving an annotation input event, e.g., via the input hardware component 228 and input driver component 230, related to the first user interface widget in response to an interaction between the first user interface widget and a user interface input device, such as the device 226. The input hardware component/driver components 228, 230 can then forward information related to the received input event to the windowing subsystem 218 and/or the annotation event monitor component 232, which can then determine the attribute of the first user interface widget. Attribute determination can be performed based on attribute information available to: (1) the windowing subsystem 218, as configured for enabling its operation; (2) an application, such as the first application 202; and (3) the annotation subsystem 234 through a predefined interface between the annotation subsystem 234 and an application for management and/or exchange of attribute information. An example of such a predefined interface includes an interface provided by the annotation subsystem 234 providing a set of functions and/or a protocol for receiving commands from the application for storing attribute information in a database, such as the annotation database 238. Attribute information can be stored using a schema accessible to the schema manager 236.

In addition to or instead of this arrangement, the annotation input event can occur upon satisfaction of an annotation rule associated with the first user interface widget. For example, an application can generate the annotation input event based on its own logic or configuration, as can the operating system 212, windowing subsystem 218, or any of a variety of components of the operating environment 204. According to one embodiment, the first application 202, the operating system 212, and/or the windowing subsystem 218 can be configured to generate an annotation input event for each menu item displayed having a menu name that has no associated or pre-defined annotation. For example, the annotation input event can be generated on a first displaying and/or selection of each menu item.

Returning to FIG. 1, in a second block 104 of the exemplary method, annotation information for the first user interface widget is received. The arrangements of FIGS. 2 and 3 include means for receiving such annotation information for the first user interface widget. For example, in FIG. 2, the first device 206 is shown to include an annotation user interface component 246 configured for, among other things, receiving such annotation information. According to an exemplary embodiment, the annotation user interface component 246 operates in conjunction with an annotation subsystem 234 and is configured to present an annotation user interface component widget for receiving annotation information for the first user interface widget.

For example, consider when a first user interface widget, e.g., the “Options . . . ” menu item widget 310, has focus, a gesture designated as being associated with an annotation input event is received by the input hardware component/driver components 228, 230 from the input device 226. The gesture information is passed, e.g., via the operating system 212, to the annotation event monitor component 232 included in the windowing subsystem 218. The annotation event monitor component 232 determines an attribute of the “Options . . . ” menu item widget 310 based on the information received from the windowing subsystem 218, and passes this attribute information to the annotation subsystem 234 and/or annotation user interface component 246 for receiving annotation information for the first widget, the options menu item widget 310.

According to an exemplary embodiment, the receiving of annotation information in the second block 104 of the exemplary method depicted in FIG. 1 can also include determining an annotation schema associated with the first user interface widget. The annotation schema can define at least one of a type and a format of the annotation information for the first user interface widget. To carry out this operation, the annotation subsystem 234 can include a schema manager component 236 that is configured to determine a schema associated with at least a portion of the attribute information determined by the annotation event monitor component 232. A schema, as used here, defines any required and/or optional types of annotation information that may be provided and defines a format for providing such annotation information. In one embodiment, the schema allows for annotation information to be provided in a format that associates a keyword with a value. A set of keywords can be predefined in some cases, allowing the user to be presented with the keywords and to supply values for at least a portion of the keywords via the annotation user interface component widget. The keyword set can be fixed or can be extensible, e.g., by the user, an administrator, and/or a provider of the first application 202 to which the first user interface widget belongs.

An annotation schema associated with the first user interface widget can be determined by accessing a data store including an attribute-schema association that includes attribute information for matching an attribute of the first user interface widget and includes an identifier of the annotation schema. The annotation schema having the identifier forming the attribute-schema association is determined to be the annotation schema associated with the first user interface widget when an attribute of the first user interface widget matches the attribute information forming the attribute-schema association. It will be understood that the term “matches” (or derivatives thereof) does not require an exact correspondence of information being compared, but instead requires that matching criteria be satisfied to constitute a match.

For example, the annotation subsystem 234 of FIG. 2 is shown to include a search/index manager component 244, operatively coupled to the schema manager component 236 that can be configured for storing and retrieving schema information in a data store, such as an annotation database 238, as depicted in FIG. 2. In one arrangement, the schema manager component 236 is configured to use the search/index manager component 244 for maintaining the attribute-schema associations and performing searches and lookups on the stored associations. The annotation database 238 may be replicated on a disk drive 240 included in the first device 206, which is accessible by the schema manager component 236 and search/index manager component 244 via a storage subsystem 242 of the device's operating environment 204.

The schema manager component 236, in conjunction with the search/index manager component 244, can use an association, including widget attribute information, for identifying one or more widgets having attributes that match the attribute information based on a matching policy or an algorithm. Such a matching rule or algorithm can require an exact match of the attribute information, can require only a partial matching of the attribute information, can include conditional matching criteria, can employ ranges, and/or can employ regular expressions. The association used to identify a schema can also include schema information identifying a schema that defines the annotation information that can be associated with widgets that match the attribute information. Consequently, the association is referred to here as an attribute-schema association. In one example, an attribute-schema association includes a widget identifier and a schema identifier, although other equivalent associations may be employed.

The schema information can identify more than one schema for use in managing annotation information associated with a particular widget or widgets having particular attributes. For example, each schema used in conjunction with receiving annotation information associated with a particular widget can be stored as separate attribute-schema associations that include attribute information and corresponding information for identifying the particular schema. Separate annotation-schema associations can be related by link tables and/or references stored in attribute-schema records for indicating relationships. In another arrangement, all annotation received corresponding to a particular type or class of widget and schema can be stored as a single attribute-schema association. It will be understood that other attribute-schema association arrangements between these extremes are possible.

The widget attribute information forming the associations may include a number of attributes of a particular widget or widget type. For example, the attribute forming the attribute-schema association can include a type of the first user interface widget, a name of the first user interface widget, a type of application the first user interface widget is associated with, a widget identifier, a format of the widget identifier, a type of widget the first user interface widget is embedded in or operates in conjunction with, and/or metadata associated with first user interface widget. It will be understood that this non-exhaustive list of attributes is exemplary. Schemas can be specified using a schema specification language, such as the resource description framework (RDF) for metadata or the document type definition (DTD). A schema can be specified in the instructions and data associated with the application 202.

The receiving of annotation information in the second block 104 of the method depicted in FIG. 1 can include presenting the annotation user interface component widget in response to at least one of an interaction between the first user interface widget and a user interface input device and satisfaction of an annotation rule associated with the first user interface widget. The annotation user interface component widget may be used for receiving the annotation information for the first user interface widget. In arrangements where a schema for providing annotation information is determined, the receiving of annotation information in the second block 104 of the method depicted in FIG. 1 can include generating an annotation user interface component widget based on the determined annotation schema.

For example, the annotation user interface component 246 described above in conjunction with FIG. 2 is configured to present a user interface, perhaps based on a determined schema, when appropriate, for receiving annotation information for the first user interface widget. Referring to FIG. 3A, consider the “Options . . . ” menu item widget 310 as the first user interface widget to be annotated. While the “Options . . . ” menu item widget 310 has focus, consider that a gesture configured to be associated with an annotation event is received by the input hardware component/driver components 228, 230 from the input device 226. The gesture information is passed via the operating system 212 to the annotation event monitor component 232 included in the windowing subsystem 218. The annotation event monitor component 232 determines an attribute of the “Options . . . ” menu item widget 310 from the windowing subsystem 218, and passes this attribute information to the annotation user interface component 246.

When a schema for annotating the widget is to be determined, the widget attribute information is also passed to the schema manager component 236, which determines an appropriate schema for annotation in conjunction with the search/index manager component 244. Any determined schema is provided to the annotation user interface component 246. The annotation user interface component 246 uses the schema provided by the schema manager component 236 to generate and present a user interface for receiving annotation information to be associated with the “Options . . . ” menu item widget 310, or if no schema is provided, the annotation user interface component 246 generates and presents a general purpose user interface for receiving the annotation information. The annotation widget dialog 312 shown in FIG. 3A is an example of a user interface generated and presented by the annotation user interface component 246 for receiving such annotation information.

The use of schemas in receiving annotation information for a user interface widget allows for the received annotation information to be managed or processed prior to its association with the widget. For example, according to an exemplary embodiment, the schema manager component 236 can be configured to format the received annotation information according to a format corresponding to the determined annotation schema. Alternatively or in addition to formatting the receiving annotation information, the schema manager component 236 can be configured for validating the received annotation information based on the determined annotation schema. The use of schemas for receiving annotation information, together with formatting and validation functionality, provides for greater uniformity in the annotation information being gathered, which, in turn, makes the sharing of such annotation information a more efficient and uniform process.

According to a related embodiment, presenting the annotation user interface component widget can include any of providing a first widget for receiving the annotation information for the first user interface widget, presenting at least one attribute of the first user interface widget via the annotation user interface component widget, providing a second widget for automatically associating the annotation information with a widget included in the first user interface widget, providing a third widget for associating the annotation information with a widget related to, but not included in, the first user interface widget and providing a fourth widget for associating user-defined help text with the first user interface widget.

For example, the annotation widget dialog 312 depicted in FIG. 3A exemplifies many of these features of a user interface for receiving annotation information. The exemplary annotation widget dialog 312 includes certain widgets for presenting known or predefined widget information, such as a type text widget 314 for indicating a widget type and a name or label text widget 316 for indicating the name of the widget, “Options . . . ” The annotation widget dialog 312 can also include a type tag widget 318 for indicating any tags (e.g., metadata) that have already been associated with the widget type, e.g., by the application 202, an administrator, or a user. For example, the exemplary “Menu Item” type shown in the annotation widget dialog 312 is indicated as being associated with a tag, “Menu Dropdown Item.”

The user can modify the tags in some embodiments while in other embodiments the tags can only be set by the application 202 or an administrator of the device 206. A tag can be assigned to the menu item type associating the tag with all widgets of that type. Tags can be assigned similarly for other widget attributes and assigned globally to a specific widget or to widgets that match the attribute information within a specified context or domain. When assignable by a user, tags are simply another form of widget annotation information that may be provided and shared by the user. Accordingly, the terms “tags” and “annotation information” are sometimes used here interchangeably.

The exemplary annotation widget dialog 312 includes an annotation information text box widget 320 for allowing the user to provide annotation information to be associated with the widget 310 having the name, “Options . . . ” It will be understood that different types of widgets may be provided (e.g., drop-down lists, radio buttons, and the like) depending on the type of widget being annotated or perhaps depending on an annotation schema associated with widget. As described above, annotation information can be associated only with the “Options . . . ” menu item widget 310 of the first application 202 and/or can be assigned to all menu item widgets having similar attributes, e.g., the name attribute of “Options . . . ,” on the first device 206 and/or on other devices (e.g., the device 410) connected via the network 404. The widgets associated with the annotation information received via the annotation information text box widget 320 can depend on the configuration of the annotation subsystem 234, and its constituent parts, included in the first device 206 and other annotation related components operating on other devices throughout the network 404.

Functionality can be included in the annotation user interface component widget allowing annotation information to be associated with the first user interface widget, e.g., the “Options . . . ” menu item widget 310, to also be associated with all widgets included in the first user interface widget. For example, selection of the “Options . . . ” menu item widget 310 by a user via the input device 226 could result in a corresponding options menu window (not shown) being presented, including a number of widgets for setting various tools options. The annotation widget dialog 312 shown in FIG. 3A includes an “Include Contents” drop-down list widget 322 having values “TRUE” and “FALSE” for receiving an indication as to whether included widgets are to be associated with the annotation information received via the dialog 312. In one type of inclusion, the annotation information received is associated with each included widget separately and optionally with other widgets matching attribute information as configured for matching attribute-schema associations. In a second type of inclusion, the widget being annotated and its included widgets are treated as a single composite widget where the annotation information received is associated with the composite widget and optionally other widgets that match the attribute information of the composite widget configured for matching, as described above.

Functionality can also be included in the annotation user interface component widget to allow widgets that reference (or navigate to) a widget being annotated to be associated with any received annotation information. Thus, were a user to instead choose to annotate the options menu window (not shown) corresponding to (and referenced by) the “Options . . . ” menu item widget 310, annotations entered by the user for the options menu window (not shown) could also be associated with the referencing “Options . . . ” menu item widget 310. This added functionality could be incorporated into the operation of the “Include Contents” drop-down list widget 322, or a separate widget to achieve the functionality could be added to the annotation widget dialog 312.

According to an exemplary embodiment, the annotation user interface component widget, e.g., the annotation widget dialog 312 shown in FIG. 3A, can also include a “Help/Advice” text box widget 324 allowing a user to enter annotation information specifically related to providing help or advice regarding the first user interface widget. A “Related Widgets” list box widget 326 can also be provided for indicating widgets that are in some way related to the widget being annotated, e.g., the “Options . . . ” menu item widget 310. In the example shown, a “Configuration Preferences” button widget included a toolbar (not shown) has been identified as being related, perhaps because both the “Options . . . ” menu item widget 310 and the this related widget allow configuration-type data to be defined. Related widgets can be added and removed from the “Related Widgets” list box widget 326 in the conventional manner, e.g., using an add button 328 and a remove button 330, respectively, as shown in the figure.

A “Save” button widget 332 can provided in the annotation widget dialog 312 for saving annotation data and for closing the dialog 312. Similarly, a “Cancel” button widget 334 may be provided for canceling the receiving of annotation information via the dialog 312. When an indication that the “Save” button widget 332 has been activated, the annotation user interface component 246 passes any entered annotation information, tag information, and attribute information of the first widget to a share manager component 248 of the annotation subsystem 234 that is configured to share the annotation information with other applications, devices, and users (described in greater detail below). The share manager component 248 is configured to use the search/index manager component 244 to create an association of the received annotation information and corresponding widget within the annotation database 238 (also described in greater detail below). In arrangements where schemas are used to manage the gathering of annotation information, the annotation user interface component 246 may also pass the annotation information to the schema manager component 236 for formatting and validation prior to sharing and association, as described above.

In the paragraphs above, the receiving of annotation information in the second block 104 of the method depicted in FIG. 1 has been described in conjunction with the arrangements shown in FIGS. 2 and 3, where the annotation subsystem 234 of the first device 206, and its constituent components, allow a user to enter annotation information for the first user interface widget via the annotation widget dialog 312. In alternative embodiments, annotation information can be received in remote devices, such as the second device 410 and annotation server 402 shown in FIG. 4. This annotation information can be sent from the first device 206 or can perhaps be sent from the annotation server 402 to one or more of the devices 206, 410. The sending (or sharing) of annotation information among devices is described in greater detail below in conjunction with a fourth block 108 of the method depicted in FIG. 1.

Returning to FIG. 1, in a third block 106 of the exemplary method, annotation information is associated with the first user interface widget using an attribute of the widget. The arrangement of FIG. 2 includes means for associating the annotation information with the first user interface widget using the attribute. For example, the search/index manager component 244 included in the first device 206 of FIG. 2 is configured to associate the annotation information with the first user interface widget using the attribute of the widget.

According to an exemplary embodiment, the search/index manager component 244, operatively coupled to the share manager component 248, is configured to create in a data store, such as the annotation database 238, an annotation-attribute association that includes attribute information for matching the attribute of the first user interface widget and includes the annotation information for the first user interface widget. The annotation-attribute association is created to associate the annotation information with the first user interface widget.

For example, if the determined attribute information includes a unique identifier (e.g., a name) of the first user interface widget, the annotation information is may be associated only with the first user interface widget. If, however, the attribute information includes a generalized attribute of the widget (e.g., a widget type), the annotation information may be associated in the database 238 with a number of widgets having a matching attribute. One skilled in the art can see that there are numerous widget attributes and widget attribute combinations that can be used in an annotation-attribute association for identifying widgets with which particular annotation information may be associated. Preferably, the annotation-attribute association is configured to allow for annotation information to be used to identify attribute information associated with one or more corresponding widgets stored in the database.

As with the attribute-scheme associations described above, annotation-attribute associations can be managed within the annotation database 238 as separate elements that can include links for relating particular associations, and/or can be managed as associations including a collection of annotation information related to a collection of attribute information. Regardless of the arrangement of information, once an association between an annotation and an attribute is located in the database 238, additional annotation and/or attribute information can be located via a link or via a structured format for managing a collection of annotation-attribute associations as a structured data record.

Annotation-attribute associations can be supported using the annotation database 416 associated with the second device 410 in much the same way as described above in conjunction with analogous components included in the first device 206. Similarly, annotation-attribute associations can be stored in and accessed from the annotation database 408 associated with the annotation server 402.

A fourth block 108 of the exemplary method depicted in FIG. 1 provides for sharing information describing the association of the annotation information and the first user interface widget with a second application that is different from the first application. The shared information enables the second application to present the annotation information in association with a second user interface widget of the second application. The arrangement of FIG. 2 includes means for sharing information describing the association of the annotation information and the first user interface widget with a second application included on the first and/or second devices.

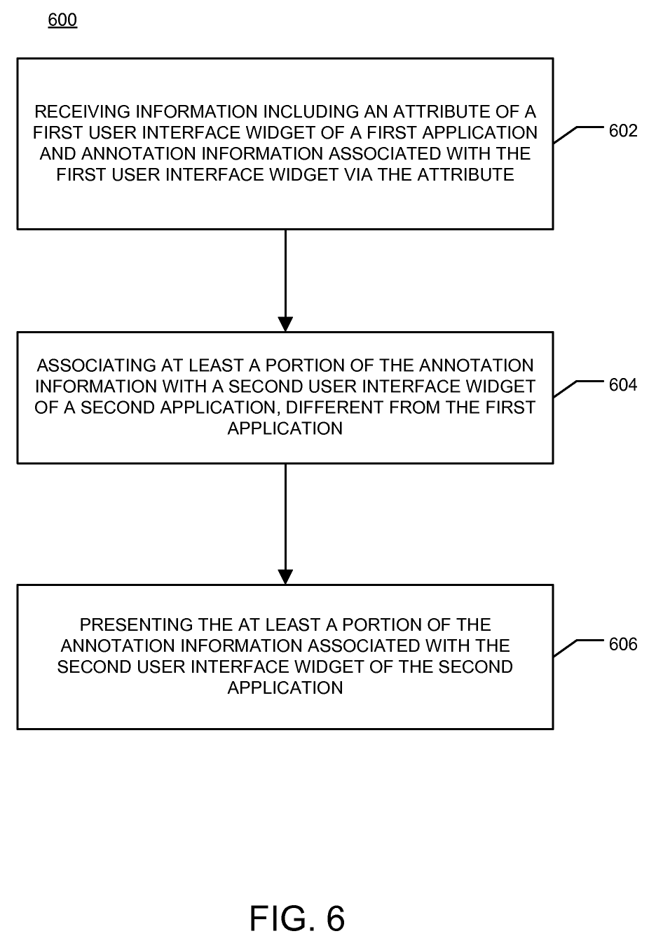

As described above, the search/index manager component 244, operatively coupled to the share manager component 248, is configured to create in a data store, such as the annotation database 238, an annotation-attribute association that includes attribute information for matching the attribute of the first user interface widget and includes the annotation information for the first user interface widget. When the second application is included on the first device 206 (a second application is not expressly shown to be included on the first device in the figures), components of the annotation subsystem 234, including the share manager component 248, are configured to enable the second application to present the annotation information in association with a second user interface widget of the second application. This operation is described in greater detail in conjunction with the exemplary method depicted in FIG. 6.

In alternative embodiments, the information describing the association of the annotation information and the first user interface widget can be shared by the first device 206 with devices coupled to the network 404, such as the second device 410 and/or the annotation server 402 shown in FIG. 4. To accommodate communication among peer devices or with a centralized server, the device 206 includes a communication subsystem 252 that is coupled to a network interface card (or NIC) 250, which together, enable the annotation subsystem 234 to exchange annotation information with other devices, e.g., the second device 410 and/or the annotation server 402, via the network 404 using appropriate communication protocols.

For example, the share manager component 248 of the first device 206 can be configured to generate a message including the information describing the association of the annotation information and the first user interface widget. The share manager component 248 can be configured to send the generated message to another client device in the network 404, such as the second device 410, using its communication subsystem 252 and NIC 250. Portions of the second device 410 shown in FIG. 4 can provide additional means for determining an attribute of the first user interface widget of the first application and for receiving annotation information for the first user interface widget, as recited in the first and second blocks 102, 104 of the method depicted in FIG. 1. For example, annotation and attribute information included in the message sent from the first device 206 can be received by an annotation subsystem 414 similar to the annotation subsystem 234 included in the first device 206. The annotation subsystem 414 can be configured to store an annotation-attribute association (or record) in an annotation database 416 associated with the second device, or the information can be discarded by the second device 410 upon use by the second application included on the second device—eliminating the need for the annotation database 416 associated with the second device. The exchanging of annotation information among and between client devices, e.g., the first and second devices 206, 410, is referred to here as peer-to-peer (or PTP) exchange.

Alternatively, the share manager component 248 of the first device 206 can be configured to generate a message, including the information describing the association of the annotation information and the first user interface widget, and to send this message using its communication subsystem 252 and NIC 250 to the annotation server 402. The annotation server 402 includes a server operating environment 504 including an operating system 524 and a processor memory 512 configured to store a number of program components that can be executed using a processor 514 included in the server operating environment 504 The operating system 524 controls access to system resources and coordinates the processing of the various components of the operating environment 504 that, together with the operating system 524, provide access to resources of the annotation server 402. The annotation server 402 can include an annotation service 406, loadable into the processor memory 512 for execution by the processor 514, having functionality similar to the functionality included in the annotation subsystems 234, 414 of the first and second devices 206, 410. The annotation server 402 can provide annotation services to devices coupled to the network 404 via the annotation service 406 along with other services (not shown).

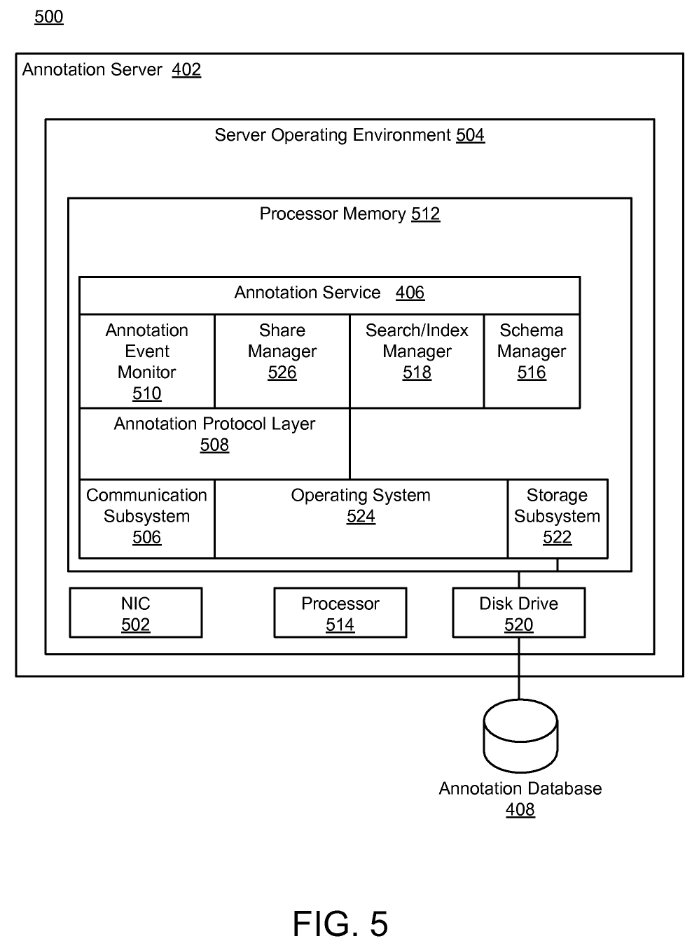

Portions of the server 402 shown in FIGS. 4 and 5 provide additional means for determining an attribute of the first user interface widget of the first application and for receiving annotation information for the first user interface widget, as recited in the first and second blocks 102, 104 of the method depicted in FIG. 1. For example, annotation information and associated widget information can be received in a message sent to the annotation server 402 over the network 404 via a NIC 502 included in the server operating environment 504. The NIC 502 is configured to relay the message through a communication subsystem 506 and an annotation protocol layer 508 of the server operating environment 504 to an annotation event monitor component 510 included in the annotation service 406. The annotation event monitor component 510 is configured to receive from the message (and thus determine) the widget attribute information for the widget of the first user interface presented by the first device 206, and to receive the annotation information for the first widget from the message.

According to an exemplary embodiment, the annotation event monitor component 510 can be configured to pass the attribute and annotation information to a schema manager component 516 of the annotation service 406. The schema manager component 516 can be configured to format and/or validate the annotation information according to a format compatible with a schema identified in the message, or perhaps based on the attribute information included in the message.

Portions of the server 402 shown in FIGS. 4 and 5 also provide additional means for associating annotation information with the first user interface widget using its attribute, as recited in the third block 106 of the method depicted in FIG. 1. For example, a search/index manager component 518 of the annotation service 406 can be configured to create an annotation-attribute association (or record) or to update an existing annotation-attribute record depending on information included in the associated annotation database 408. Instead of or in addition to storing attribute and annotation information in the database 408, such information may be stored on a disk drive 520 and accessed by the annotation service 406 under control of a storage subsystem 522. The attribute and annotation information stored in the associated annotation database 408 can be shared with other devices coupled to the network, such as the second device 410, upon request. This type of exchange of annotation information is referred to here as a client-server exchange.

As discussed above, persons skilled in the art will understand that one of the first or second devices 206, 410 can be configured to operate as a server in relation to the other of the devices. Accordingly, portions of the second device 410 shown in FIG. 4 can provide additional means for determining an attribute of the first user interface widget of the first application, for receiving annotation information for the first user interface widget, and for associating annotation information with the first user interface widget using its attribute, as recited in the first, second, and third blocks 102, 104, 106 of the method depicted in FIG. 1. In particular, components of the first device 206 depicted in FIG. 2 (which will be understood to be substantially similar to the components of the second device 410) that are analogous to the components of the annotation server 402 depicted in FIG. 5 may be used in the manner described above to carry out the tasks depicted the first, second, and third blocks 102, 104, 106 of the method depicted in FIG. 1. Consequently, the distinction here between peer-to-peer and client-server exchanges can, at times, be negligible or non-existent.

The arrangement of FIG. 5 includes additional means for sharing information describing the association of the annotation information and the first user interface widget with a second application, such as the second application 412 included on the second device 410 or perhaps a second application included on the first device 206 (not shown in the figures). For example, the annotation service 406 included in the annotation server 402 can include a share manager component 526. The share manager component 526 can be configured to receive a message from a device (e.g., from the first or second devices 206, 410 via the network 404) including a request for annotation information matching attribute information included in the request (this operation is describe in greater detail below). The share manager component 526 of the annotation service 406 can be configured to generate a message including the requested annotation information and to transmit the message to the requesting device 206, 410.

According to an exemplary embodiment, the shared information includes at least a portion of the annotation information for the first user interface widget and an attribute of the first user interface widget. For example, the share manager component 248 of the first device 206 can be configured to include, as shared annotation information, some or all of the annotation information provided via the annotation information text box widget 320 of the widget dialog 312 shown in FIG. 3A. In addition, any or all of the information provided via other widgets included in the widget dialog 312, such as the “Help/Advice” text box widget 324 or the “Related Widgets” list box widget 326, can be included in the shared information. Along with the annotation information, the shared information can also include attribute information, such as a type of the first user interface widget, a name of the first user interface widget, a type of application the first user interface widget is associated with, a widget identifier, a format of the widget identifier, a type of widget the first user interface widget is embedded in or operates in conjunction with, and/or metadata associated with first user interface widget.

In addition, the share manager component 248 can include an identifier of an annotation schema associated with the attribute of the first user interface widget in the shared information. As described above, the annotation schema can be used to define at least one of a type and a format of the annotation information for the first user interface widget. The schema identifier and can also be used in a receiving device (e.g., by the schema manager component 236 of the first device 206 shown in FIG. 2 and/or by the schema manager component 516 of the annotation server 402 shown in FIG. 5) to select a schema for validating and/or formatting any received annotation information.

As described above, the annotation information can be either stored locally for use (or sharing) by applications included on the first device 206 (e.g., sharing among applications stored on the first device 206) or can be sent to remote devices, such as the second device 410 and/or the annotation server 402. For example, sharing the information comprises sending the information describing the association of the annotation information and the first user interface widget in at least one of a first message sent from a first device including the first application to a second device including the second application, a second message sent from the first device including the first application to a server, and a third message sent from the server to the second device including the second application.

According to another exemplary embodiment, a request can be received for annotation information for the first user interface widget. The request can include an attribute of the first user interface widget. A data store can be accessed including an annotation-attribute association that includes annotation information for matching an attribute of the first user interface widget and includes the annotation information. The annotation information to share with the second application can be determined based on the annotation information forming the annotation-attribute association when the attribute included in the request matches the annotation information forming the annotation-attribute association.

For example, in the arrangements shown in FIGS. 4 and 5 depicting the annotation server 402 and second device 410, the share manager component 526 of the annotation server 402 can be configured to receive a message from the second device 410 including a request for annotation information matching attribute information included in the request. The message, including the request, can be received via the network 404 by the server 402 using its NIC 502 and communication subsystem 506, and can be processed using the annotation protocol layer 508 configured for receiving such annotation request messages. The message contents can be passed via the protocol layer 508 directly to the share manager component 526 or can be passed to the annotation event monitor component 510 and then forwarded to the share manager component 526 to process the request. The share manager component 526 is configured to use the widget attribute information included in the message to request a search of its annotation database 408 for annotation information that is associated with the attribute information. The share manager component 526 can be configured to use the search/index manager component 518 included in the annotation service 406 for generating a query of the annotation database 408 using the widget attribute information.

The annotation database 408 can be configured to identify annotation-attribute associations (or records) stored in the database 408 when the widget attribute information used in the query matches the widget attribute information included in the database record. Annotation information from a matching record or records can be returned by the database 408 to the search/index manager component 518. Alternatively, the database 408 can be replaced with a data store and the logic for query submission and record matching can be included in the search/index manager component 518. The storage subsystem 522 of the annotation server 402 can be used to manage/control access to and from the annotation database (or data store) and the hard drive 520 can be included in the server 402 for caching or storing some or all of the information included in the annotation database 408. The query results can be returned to the share manager component 526, which can be configured to generate a response message including at least a portion of the query results. The response message can be transmitted to the requesting second device 410 using the communication subsystem 506 and NIC 502 of the annotation server 402.

It will be understood that while the annotation server 402 shown in FIG. 5 is used above to describe the receiving of a request for annotation information for the first user interface widget and the subsequent processing and response to such request, persons skilled in the art will understand that any of the client devices (e.g., the first and second devices 206, 410) coupled via the network 404 include components and functionality similar to that described in conjunction with the annotation server 402 to receive and process requests for annotation information sent by other devices coupled to the network 404.

According to another exemplary embodiment, the information describing the association of the annotation information and the first user interface widget can be automatically shared with the second application based on a subscription to annotation information associated with the first user interface widget. For example, the annotation service 406 of the annotation server 402 can be configured to send notifications to the second device 410 based on a subscription for annotation information matching widget attribute information established for the second device 410. The subscription can be established automatically by the server 402, established based on a subscription request received from the second device 410, and/or based on a subscription request received from another device, such as the first device 206. Alternatively or in addition to sending annotation information via a subscription, annotation information associated with the first user interface widget can be automatically shared with the second application when included on the second device 410 at the direction (or by instruction) of the first device 206, thus providing additional means for sharing the information describing the association the annotation information and the first user interface widget with the second application, as recited in the fourth block 108 of method depicted in FIG. 1.

FIG. 6 depicts another exemplary method for sharing user interface widget annotations. In a first block 602 of the method, information is received including an attribute of a first user interface widget of a first application and annotation information associated with the first user interface widget via the attribute. As described above, the information including the attribute and the annotation information for the first user interface widget can be received in a first message sent from a first device (e.g., the first device 206) including the first application to a second device (e.g., the second device 410) including the second application. In an alternative embodiment, the information can be received by the second device including the second application in a message sent from the server rather than from first device.

Accordingly, means for receiving information including attribute information matching the attribute of the first user interface widget and associated annotation information are shown in FIGS. 2 and 4. For example, the second device 410 shown in FIG. 4 can be configured to receive a message sent by the annotation service 406 of the annotation server 402 and/or by the share manager component 248 of the first device 206 via the network 404. The second device 410 can include components similar to those of the first device 206 shown in FIG. 2, and in particular can include a NIC 250 and a communication subsystem 252 configured to receive the message including the attribute and annotation information. The message can be routed to an annotation subsystem 234 of the second device 410 configured to cache the annotation information and its associated widget attribute information in a record in an annotation database 416, as described above in conjunction with the first device 206 and its corresponding annotation database 238. Alternatively, the annotation subsystem 234 of the second device 410 can be configured to use the attribute and associated annotation information without storing/creating a corresponding record in its local database 416.

In yet another alternative embodiment, the information including the attribute and the annotation information for the first user interface widget can be received in a second message sent from the first device (e.g., the device 206) including the first application to a server (e.g., the server 402). Accordingly, additional means for receiving the information including the attribute and annotation information for the first user interface widget are depicted in FIG. 5, including the NIC 502, communication subsystem 506, annotation protocol layer 508, and annotation event monitor component 510. Operation of these components in receiving attribute and annotation information has been described in detail above, and need not be repeated here.

In a second block 604 of the method illustrated in FIG. 6, at least a portion of the annotation information is associated with a second user interface widget of a second application, different from the first application. Thus, the same annotation information (or at least a portion thereof) associated with the first user interface widget (e.g., the “Options . . . ” menu item widget 310) of the first application (e.g., the first application 202 included in the first device 206) is also associated with a second user interface widget (not shown) of a second application (e.g., the second application 412 included in the second device 410), effecting a sharing of the annotation among the first and second widget and first and second applications. Preferably, the second user interface widget provides similar functionality in the second application (e.g., the second application 412) to that provided by the first user interface widget (e.g., the “Options . . . ” menu item widget 310) of the first application (e.g., the first application 202).

According to an exemplary embodiment, the at least a portion of the annotation information is associated with the second user interface widget by creating, in a data store, an annotation-attribute association that includes attribute information matching the second user interface widget and includes the at least a portion of the annotation information to associate the at least a portion of the annotation information with the second user interface widget. When the second application is included on the first device 206 (an arrangement not depicted in the figures), the components of the first device 206 described above for creating an annotation-attribute association (or record) in the annotation database 238 for the first user interface widget 310 provide means for associating the at least portion of the annotation information with the second user interface widget. For example, the attribute information in the annotation-attribute association can match an attribute of the first user interface widget 310 and can match an attribute of the second user interface widget. Alternatively, these same components can be configured to also create a second annotation-attribute record in the annotation database 238 with attribute information matching the attribute of the second user interface widget, thus associating the at least portion of the annotation information with the second user interface widget.

In alternative embodiments, the second application is included on a second device, such as the second device 410. In such embodiments, the association of the at least a portion of the annotation information with the second user interface widget can occur under control of the second device or another device, such as the server 402 depicted in FIG. 4. Again, embodiments have been described above where the second device 410 and/or the server 402 include components that provide means for associating the at least portion of the annotation information with the second user interface widget. For example, components of the second device 410 and/or annotation server 410 described above that are configured to create an annotation-attribute association (or record) in an annotation database (e.g., the database 416 and/or the database 408) for the first user interface widget 310 can also be configured to create another annotation-attribute record in an annotation database (e.g., the database 416 and/or the database 408) associating the at least portion of the annotation information with the second user interface widget, or to create an annotation-attribute association with attribute information that matches both the attribute of the first user interface widget 310 and the second user interface widget. The reader is directed to those portions of the description above for more detailed information regarding this operation. Moreover, the reader is reminded of embodiments described above where a client device, such as the first device 206, can be configured to operate in a similar manner to the server 402 depicted in FIGS. 4 and 5 (albeit in a PTP arrangement) when the second application is included on a second device, such as the second device 410.

Once associated with an attribute of the second user interface widget, the associated portion of the annotation information can be used to present annotation when needed. The need for such annotation information can arise, for example, when receiving an annotation output event related to the second user interface widget. The annotation output event can be received in response to an interaction between the second user interface widget and a user interface input device. Alternatively, the annotation output event can be received upon satisfaction of an annotation rule associated with the second user interface widget.

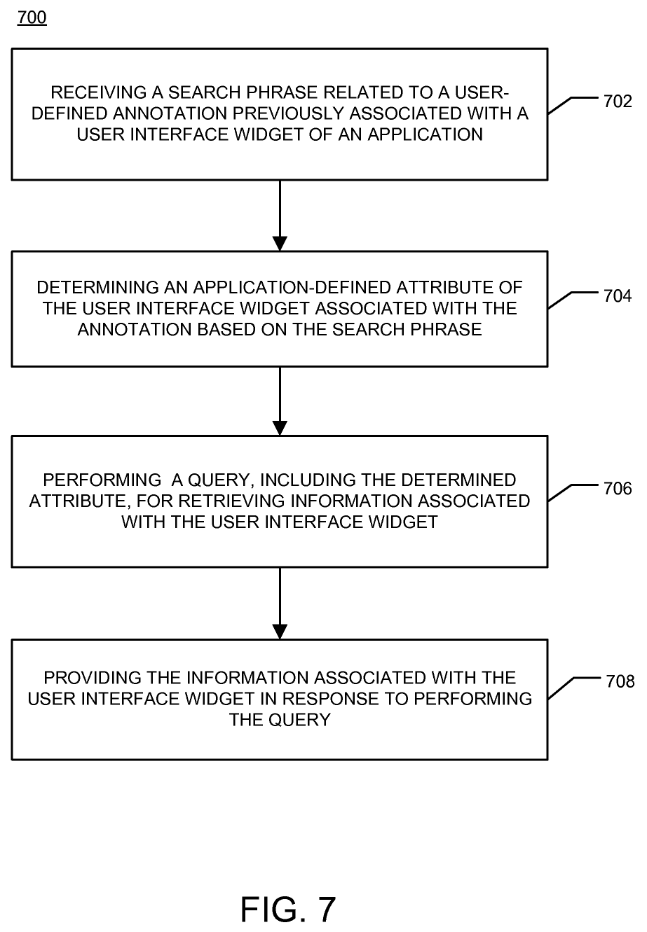

For example, in an embodiment in which the second application (e.g., the second application 412) is included in the second device 410, the annotation output event can be received and processed using components of the second device 410 that are similar to those included in the first device 206. For example, the annotation output event can be received via an input device 226 and an input driver component 230 and then passed to a windowing subsystem 218 where the event is associated with a widget, such as a second widget of the second application 412. The annotation output event can be associated with a request requiring annotation information for the second widget, such as a presentation of a tooltip, a request to view annotation information associated with the second widget, or as a result of a search using a term associated with an instance of annotation information (described in greater detail below in conjunction with FIGS. 3B and 7).

In an embodiment using a data store (e.g., annotation database 416) local to the second device 410, the request can be passed to an annotation event monitor component 232. The annotation event monitor component 232 can be configured to determine an attribute of the second user interface widget, in conjunction with the windowing subsystem 218, in response to receiving the annotation output event. The annotation event monitor component 232 is configured to use other components of an annotation subsystem 234 of the second device 410 to locate the at least portion of the annotation information associated with the second user interface widget in the given context.

For example, a share manager component 248 of the second device 410 can be configured to use the determined attribute information of the second widget to request a search of its annotation database 416 for annotation information that is associated with the attribute information. The share manager component 248 can be configured to use a search/index manager component 244 for generating a query of the annotation database 416 using the widget attribute information. The annotation database 416 can be configured to identify annotation-attribute associations (or records) stored in the database 416 when the widget attribute information used in the query matches the widget attribute information included in the database record. Annotation information from a matching record or records can be returned by the database 416 to the search/index manager component 244.

Instead of or in addition to querying a local data store, the annotation subsystem 234 of the second device 410 can be configured to send a message to an annotation service 406 of the annotation server 402 including attribute information of the second widget that can used for locating and matching annotation-attribute records in its associated annotation database 408. The server 402 can be configured to send a response message with information, including the at least a portion of the annotation information, located in the database 408 having records that match the attribute information of the second widget.

For example, the share manager component 526 of the server 402 is configured to use the widget attribute information included in the message to request a search of its annotation database 408 for annotation information that is associated with the attribute information. The share manager component 526 can be configured to use the search/index manager component 518 included in the annotation service 406 for generating a query of the annotation database 408 using the widget attribute information. The annotation database 408 can be configured to identify annotation-attribute associations (or records) stored in the database 408 when the widget attribute information used in the query matches the widget attribute information included in the database record. Annotation information from a matching record or records can be returned by the database 408 to the search/index manager component 518.

In a third block 606 of the method depicted in FIG. 6, the at least a portion of the annotation information associated with the second user interface widget of the second application is presented. Components of the first device 206 (and the second device 410, for that matter) provide means for presenting the annotation information associated with the second user interface widget of the second application. For example, the windowing subsystem 218, using drawing capabilities of the graphics subsystem 220, can be configured to created representations of the at least a portion of the annotation information in a display buffer (not shown) accessible to a graphics card 222. The graphics card 222 is operatively coupled to a display device 224 configured to present the contents of the display buffer.

According to an exemplary embodiment, presenting the at least a portion of the annotation information includes generating a display of the at least a portion of the annotation information in response to receiving the annotation output event. As described above, the annotation output event can be associated with a request requiring annotation information for the second widget, such as a presentation of a tooltip, a request to view annotation information associated with the second widget, or as a result of a search using a term associated with an instance of annotation information the generated display presented in association with the second user interface widget based on a schema associated with the portion of the annotation information and based on a context of the annotation output event.

### Using Annotated User Interface Widgets in Search Operations

FIG. 7 is a flowchart illustrating a method for using annotated user interface widgets in search operations. The method illustrated in the flow diagram of FIG. 7 can be carried out using the exemplary device and user interface depicted in FIGS. 2 and 3, respectively, and the exemplary device shown in FIG. 5, portions of which are referenced below for illustration purposes.

In a first block 702 of the exemplary method depicted in FIG. 7 a search phrase related to a user-defined annotation previously associated with a user interface widget of an application is received. For example, means for receiving the search phrase related to a user-defined annotation previously associated with a user interface widget of an application can include, among other things, the annotation user interface component 246 of the first device 206 shown in FIG. 2. According to an exemplary embodiment, the annotation user interface component 246 can be configured to present a search user interface widget in response to an activation of a user interface control via a user interface input device.

For example, as will be understood by those of ordinary skill in the art, the first application 202 (or the second application 412, or both) can be configured to provide help information to users of the first application 202 via a help menu widget, such as the “Help” menu widget 308 shown in the user interface illustrated in FIG. 3B. The application 202 will typically provide a search capability, accessible to a user via a search menu item widget, such as the “Search . . . ” menu widget 350 shown in FIG. 3B.

According to an exemplary embodiment, while the “Search . . . ” menu item widget 350 has focus, an input event can be received by the input hardware component/driver components 228, 230 from the input device 226. The input event is passed via the operating system 212 to the annotation event monitor component 232 included in the windowing subsystem 218. In the arrangement shown in FIG. 2, the annotation subsystem 234 is a part of the operating environment 204 available to any application. Thus, the annotation event monitor component 232 can be included in the windowing subsystem 218. The annotation event monitor component 232 determines an attribute of the “Search . . . ” menu item widget 350 from the windowing subsystem 218, and passes this attribute information to the annotation user interface component 246. The annotation user interface component 246 is configured to generate and present a search user interface widget for receiving the search phrase related to a user-defined annotation previously associated with a user interface widget. The search user interface widget 352 shown in FIG. 3B is an example of a user interface generated and presented by the annotation user interface component 246 for receiving such a search phrase.

As described above, the functionality of the annotation event monitor component 232 can be integrated into an application, such as the first application 202, or a family of applications. With such an arrangement, the application 202 can be configured to receive events through its event monitor as determined by an application event router or event handler (not shown), while interoperating with the windowing subsystem 218 to manage widget attributes. Still another arrangement can employ both the annotation event monitor component 232 included in the operating environment 204 and functionality of the annotation event monitor component 232 as part of the application 202 to cooperatively or independently perform the methods described here. Varying degrees of integration of the functionality of the annotation subsystem 234 and its subcomponents into the application 202 can also occur without deviating greatly from the scope of the subject matter described here. For example, the annotation subsystem 234 can be provided as a part of the operating environment 204 available for use by applications and/or can be provided as an annotation subsystem of an application or family of applications.

In yet another arrangement, the input indication can be received by the windowing subsystem 218 and then passed to the user interface controller 216. The user interface controller 216 is configured to present, via the windows subsystem 218 and associated components as described above, the search user interface widget 352 shown in FIG. 3B. With this arrangement, the user interface controller 216 is configured to present a search user interface widget and to pass information entered via the search user interface widget 352 to the annotation subsystem 234 for further processing via an application programming interface (or API, not shown) provided by the annotation subsystem 234. The API allows the application 202 and the operating-environment-provided annotation subsystem 234 to cooperate in performing the methods described here.

According to an exemplary embodiment, the search user interface widget includes at least a first widget for receiving the search phrase and a second widget for presenting the information associated with the user interface widget provided in response to performing the query. For example, the search user interface widget 352 shown in FIG. 3B includes a text input widget 354, shown in the figure to have the label “Enter Search:” The text input widget 354 allows a user to provide a search phrase related to the user-defined annotation previously associated with a user interface widget. The search phrase is received and processed by the annotation user interface 246 as depicted in FIG. 2 and/or by the user interface controller 216 of the application 202, depending on the embodiment. As will be understood by those of ordinary skill in the art, the search phrase can include words, quoted text, and, in some embodiments, Boolean operations (e.g., “and,” “or,” and “not”) and parenthesis or other similar delimiters for specifying the order of processing of a search string. Moreover, the term “phrase” should not lead the skilled artisan to believe that more than one term or word need be entered.

Additional means for receiving the search phrase related to a user-defined annotation previously associated with a user interface widget of an application can include, among other things, the annotation event monitors 510, 232 of the annotation server 402 and the second device 410, respectively as shown in FIGS. 2, 4 and 5.

For example, the search phrase related to a user-defined annotation previously associated with a user interface widget can be received in a message sent to the annotation server 402 over the network 404 via the NIC 502 included in the server operating environment 504. The NIC 502 is configured to relay the message through the communication subsystem 506 and the annotation protocol layer 508 of the server operating environment 504 to the annotation event monitor component 510 included in the annotation service 406. The annotation event monitor component 510 is configured to receive the search phrase from the message.

In addition, persons skilled in the art will understand that one of the first or second devices 206, 410 can be configured to operate in the role of a server in relation to the other of the devices. Accordingly, portions of the second device 410 shown in FIG. 4 can provide additional means for receiving the search phrase related to a user-defined annotation previously associated with a user interface widget, as recited in the first block 702 of the method depicted in FIG. 7. In particular, components of the first device 206 depicted in FIG. 2 (which will be understood to be substantially similar to the components of the second device 410) that are analogous to the components of the annotation server 402 depicted in FIG. 5 may be used in the manner described above to carry out such tasks.

In a second block 704 of the method depicted in FIG. 7 an application-defined attribute of the user interface widget associated with the annotation is determined based on the search phrase. For example, means for determining an application-defined attribute of the user interface widget associated with the annotation is based on the search phrase can include, among other things, the search/index manager components 244, 518 of the first and second devices 206, 410 and of the annotation server 402, respectively.

According to an exemplary embodiment, the search/index manager components 244, 518 can be configured to access a data store including an annotation-attribute association that includes annotation information for matching the search phrase related to the user-defined annotation and the application-defined attribute of the first user interface widget. For example, the search/index manager component 244 of the first and second devices 206, 410 can be configured to generate a query for searching the annotation database 238, 416 using the search phrase received via the search user interface widget 352. Alternatively or additionally, the query including the search phrase can be transmitted in a message sent from one of the devices 206, 410 via each device's respective NIC 250 and communication subsystem 252 to a peer device 410, 206. The annotation database 238, 416 can be configured to identify annotation-attribute associations (or records) stored in the database 238, 416 when the search phrase related to the user-defined annotation used in the query matches the annotation information included in the database record. Attribute information from a matching record or records can be determined and returned by the database 238, 416 to the search/index manager component 244. Alternatively, the database 238, 416 can be a simple data store and all logic necessary to determine a matching record may be included in the search/index manager component 244.

Consider an example when the term “preferences” is received as a search phrase via the text input widget 354 of the search user interface widget 352. Recall from the description of FIG. 3A above that, in one example, “Preferences” is provided as an annotation for the “Options . . . ” menu item widget 310. Querying the annotation database 238, 416 with the search phrase “preferences” matches those annotation-attribute records having “preferences” in the annotation information portion of the record. At least one of the records includes the name of the widget, “Options,” in the attribute information portion of the record. Thus, “Options” is an attribute of the “Options . . . ” menu item widget 310 determined using the search phrase “preferences.”

Instead of or in addition to querying a local data store or sending a query to a peer device, the annotation subsystem 234 of the first or second devices 206, 410 can be configured to send a message to an annotation service 406 of the annotation server 402 including the search phrase related to the user-defined annotation that can used for locating and matching annotation-attribute records in its associated annotation database 408. The server 402 can be configured to send a response message including attribute information included in one or more annotation-attribute records in its database 408 where the search phrases matches the corresponding annotation information of the record(s).

For example, the service 406 is configured to use the search phrase related to the user-defined annotation included in the message to request a search of its annotation database 408 for attribute information that is associated with the search phrase. The search/index manager component 518 included in the annotation service 406 is configured for generating a query of the annotation database 408 using the search phrase. The annotation database 408 can be configured to identify annotation-attribute associations (or records) stored in the database 408 when the search phrase used in the query matches the annotation attribute information included in the database record. Attribute information from a matching record or records can be returned by the database 408 to the search/index manager component 518.

According to an exemplary embodiment, the attribute of the user interface widget can include content included in the user interface widget. A text box widget, for example, includes text. The included text is an attribute of a text box widget. Widget content can be application-defined and/or user-defined depending on the widget type and its role in the application 202. For example, an application defined attribute can have an application-defined identifier and user-defined content, such as a configuration option. Because the user-defined content is closely tied within the application 202 to the widget, the widget content itself may be considered to be application-defined for purposes here.

In another example, the annotation subsystem 234 can be configured to receive user-defined help and advice related to, for example, the use of a function or feature of an application in a particular business-, home-, or community-related specific task for which the software provider provides inadequate or no help. Consider, for example, user annotations associated with the widgets of a spreadsheet application related to a trucking company purchasing process. A spreadsheet can be loaded into an application and displayed using widgets. Because the content of a widget is included in an attribute of the widget itself, one can use an application search (e.g., an application-provided “find” function) to locate content and/or help associated with a particular content, where the search includes annotation information that is associated with the content of the, and thus is associated with the widget. The information provided in response to performing the query can include at least a portion of the content included in the user interface widget as well as additional information as is described below.

According to an exemplary embodiment, a second user-defined annotation associated with the user interface widget is determined based on the annotation information when the search phrase matches the annotation information. The second user-defined annotation can be determined using a link in the annotation database 238, 416, 408 representing a relationship between the annotation-attribute record found in performing the query including the search phrase related to the first user defined annotation information. Alternatively or additionally, a second user-defined annotation associated with the user interface widget can be determined based on the inclusion of the second user-defined annotation in the annotation-attribute record located by the search.

The second user-defined annotation can include, for example, user-defined help text and/or an identifier of a second user interface widget related to the user interface widget of the application. For example, when an annotation-attribute record is located in the annotation database 238, 416, 408 by the search/index manager component 244, 518 that matches the search phrase, in addition to determining the attribute of the user interface widget, the search/index manager component 244, 518 can be configured to determine additional annotation information associated with the matching record or records as described in the paragraph above.

For example, as described above in conjunction with FIG. 3A, the “Help/Advice” text box widget 324 is provided to allow a user to enter annotation information specifically related to providing help or advice regarding the first user interface widget. The “Related Widgets” list box widget 326 is provided for indicating widgets that are in some way related to the widget being annotated in the same user interface widget 312 through which the help annotation is received. Annotation information received via an annotation user interface, such as the annotation widget dialog 312 described above, can be stored in the database 238, 416, 408, preserving the relationships identified via input received in user interaction with the annotation widget dialog 312 as previously described.

Additional annotation information can be included in the information provided in response to performing the query. For example, a query generated from a search term “preferences,” when performed by the search/index manager 236 on annotation-attribute records in the annotation database 238, 416, 408 can locate the annotation-attribute record associating the term, “preferences” with the “Options . . . ” name attribute of the “Options . . . ” menu item 310. The annotation-attribute record can contain a field for storing or referencing any help annotation received via the Help/Advice widget 324 along with the “preferences” term via the Annotation Information widget 320.

In a third block 706 of the method depicted in FIG. 7, a query, including the determined attribute, is performed for retrieving information associated with the user interface widget. For example, means for performing the query, including the determined attribute, for retrieving information associated with the user interface widget can include, among other things, an application-provided search/index manager (not shown) for searching an application provided database and/or the search/index manager components 244, 518 of the first and second devices 206, 410, and/or of the annotation server 402. A combination of application-provided and annotation-subsystem-provided search/index manager components and/or storage provides additional exemplary means for performing the query.

According to an exemplary embodiment, a search/index manager component, such as the search/index manager component 244, 518 is configured to receive the query and access an index of searchable information typically provided by the application 202, but can be augmented by related applications and their user(s) in some embodiments. For example, the searchable index can be a keyword-help table, where a keyword is a word or a phrase included in a page or section of help referenced by a record in the table, is such an index. A portion of the searchable information included in the index, such as a help keyword, is determined that matches the determined attribute included in the query. In an exemplary keyword-help record, a keyword column can be configured and a column for a reference to a help section that contains the keyword can be configured. The query is used to locate a record where there is at least a partial match between the attribute information included in the query and the data in the keyword column of the record. The portion of the searchable information, such as a reference to a help section, and/or information indexed by the portion of searchable information, such as the referenced help section, is determined as the information associated with the user interface widget.

For example, in the scenario described above, “Options” was determined to be a name attribute of the “Options . . . ” menu item widget 310 using the search phrase “preferences.” The term “Options” can be identified as a keyword in a searchable index, such as the keyword-help table described above. Both the keyword, “Options,” and corresponding help text provided by the application can be determined by the search/index manager component 244, 518. Accordingly, a user not knowing an application's particular terminology “Options” is able to locate help related to the “Options” function by using the term “preferences” that the user, in the example, associates with the same type of information.

Alternatively, an application 202 can perform the query including the determined attribute using an application database (not shown). In yet another arrangement, the search/index manager component 244, 518 can be provided with configuration information, for example by an application 202, allowing the search/index manager component 244, 518 to access an application database. The application database uses a database schema known to or detectable by the search/index manager component 244, 518. Configured in this way, the search/index manager component 244, 518 can perform the query as described above. In still another arrangement, the search/index manager component 244, 518 can be configured to provide a determined attribute to an application 202 via an API of the application 202 known to the search/index manager component 244, 518 or via a protocol supported by both the application 202 and the search/index manager component 244, 518. In this arrangement, the API and/or protocol enables the search/index manager component 244, 518 to provide the determined attribute to the application 202 for performing a query including the determined attribute for receiving information associated with the user interface widget.

According to yet another alternative arrangement, the information included in the search indices of the application 202 can be stored and/or replicated in the annotation database 238, 416, 408, or other data store, to allow the search/index manager component 244, 518 to retrieve information associated with the user interface widget by performing a query including the determined attribute.

In another embodiment, a second application-defined attribute of and/or a second user-defined annotation previously associated with the user interface widget is determined based on the determined the portion of the searchable information and/or the information indexed by the portion of searchable information. A second query, including the second determined attribute and/or the second user-defined annotation, can be performed for retrieving additional information associated with the user interface widget. The additional information may be included in the information provided in response to performing the query. For example, the search/index manager 236 can locate related annotation information and/or attribute information using the determined attribute, such as the “Options . . . ” name attribute, and type information of the “Options . . . ” menu item widget. Examples of related annotation information that can be located include the help information provided in the Help/Advice text box 324 of the annotation widget dialog, the term “preferences” received in the annotation information text box 320, and any related widgets received via the related widgets controls 326 328 330.

Accordingly, a plurality of queries of the annotation database 238, 416, 408 for attribute information, additional annotation information, and of the application's searchable data can be generated. Further, at least a portion of the plurality can be alternatively generated using the results of a query of the application's 202 searchable index as the search phrase to determine other possible attributes of the user interface widget. This technique allows relationships beyond the first level relationships indicated by the annotation-attribute records to be located and followed. The level of searching can be configurable by a user or may be determined automatically by the application 202. Alternatively, the annotation subsystem 234 or annotation service 406 can make this determination based on the results returned by the various queries at each level of search.

In a fourth block 708 of the method depicted in FIG. 7, the information associated with the user interface widget is provided in response to performing the query. For example, means for providing the information associated with the user interface widget in response to performing the query can include, among other things, the annotation user interface component 246 of the first device 206 shown in FIG. 2. According to an exemplary embodiment, the annotation user interface component 246 can be configured to present a search user interface widget including at least one of a link to and a displayable representation of the various information mined from the annotation databases 238, 416, 408 and the searchable indexes of the application 202. For example, links to information or the information itself can be presented in a list box widget, such as the results list box widget 356 shown in FIG. 3B.

Information included in the results list box widget 356 can include the determined attribute of the user interface widget; annotation information associated with the determined attribute, such as a user-defined name for the widget; at least one of a portion of searchable information included in an index, such as a keyword, provided by the application and information indexed by the portion of searchable information, such as help text corresponding to the keyword; user-defined help text; an identifier of a second user interface widget related to the user interface widget of the application; and content included in the user interface widget.

Continuing with the scenario introduced above, a determination using a search phrase related to a user-defined annotation, such as the phrase “preferences,” is used to identify attribute information, such as the widget name, “Options.” The attribute “Options” is then used to search the help index of the application 202, where application-defined help text on the “Options” function is found. This result is indicated as a link “Options” to the application-defined help text in the results list box widget 356. In the example, “preferences” is also a user-defined annotation for annotating a widget having the name “Configuration Preferences.” Thus, the attribute “Configuration Preferences” can also be determined by examining the annotation database 238, 416, 408. The attribute “Configuration Preferences” is then used to query the application's 202 help index, where additional application-defined help text is located. A link, having the name “Configuration Preferences” is also shown in the results list box widget 356.

Recall from the discussion of FIG. 3A that the “Configuration Preferences” widget was identified by the user as being related to the “Options . . . ” menu item widget 310. This relationship is indicated in the results list box widget 356 by the two entries having the prefix “Related.” Recall in the examples above that user-defined help text could be entered for the “Options . . . ” menu item widget 310 via the “Help” menu widget 308. A link corresponding to this text is indicated in the results list box widget 356 via the “User Help:” prefix. Note that since no such prefixed entry exists for the “Configuration Preferences” widget, no such text is found to exist in the example.

Alternative means for providing the information associated with the user interface widget in response to performing the query can include, among other things, the share manager components 248, 526 of the first and second devices 206, 410 and of the annotation server 402, respectively. These components, along with other components of these devices, are used to provide information related to the user interface widget by querying either local or remote databases in the same manner as these devices have been described above in connection with sharing widget annotation information. Accordingly, the devices 206, 410, and 402 shown in FIG. 4 can operate in PTP or client-server arrangements for using annotated user interface widgets in search operations.

The executable instructions of a computer program for carrying out the methods illustrated in FIGS. 1, 6, and 7 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

The methods and apparatus described above allow users to annotate user interface widgets and search for information associated with the widgets using the annotations as keywords for the search. Annotations and searching can be applied to both application widgets (e.g., browser and corresponding browser pages) and system widgets (e.g., desktop and handheld operating systems). By allowing users to annotate a widget, the user is able to associate the widget with a term or terms that are meaningful to the user, thereby creating a semantic relationship between an annotation and a widget which others may find meaningful and useful. The association enables a number of operations based on a search or lookup using an annotation and/or widget attribute as a portion of the search query or lookup key.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for sharing user interface widget annotations, the method comprising:
determining an attribute of a first user interface widget of a first application;
receiving annotation information for the first user interface widget;
associating the annotation information with the first user interface widget using the attribute; and
sharing information describing the association of the annotation information and the first user interface widget with a second application, different from the first application, the shared information enabling the second application to present the annotation information in association with a second user interface widget of the second application.

2. The method of claim 1, wherein determining an attribute comprises:
receiving an annotation input event related to the first user interface widget in response to at least one of an interaction between the first user interface widget and a user interface input device and satisfaction of an annotation rule associated with the first user interface widget; and
determining the attribute of the first user interface widget in response to receiving the annotation input event.

3. The method of claim 1, wherein receiving annotation information comprises determining an annotation schema associated with the first user interface widget, the annotation schema defining at least one of a type and a format of the annotation information for the first user interface widget.

4. The method of claim 3, wherein determining an annotation schema associated with the first user interface widget comprises:
accessing a data store including an attribute-schema association that includes attribute information for matching an attribute of the first user interface widget and includes an identifier of the annotation schema; and
determining the annotation schema having the identifier forming the attribute-schema association as the annotation schema associated with the first user interface widget when an attribute of the first user interface widget matches the attribute information forming the attribute-schema association.

5. The method of claim 4, wherein the attribute information forming the attribute-schema association includes at least one of a type of the first user interface widget, a name of the first user interface widget, a type of application the first user interface widget is associated with, a widget identifier, a format of the widget identifier, a type of widget the first user interface widget is embedded in or operates in conjunction with, and metadata associated with first user interface widget.

6. The method of claim 3, wherein receiving annotation information comprises:
generating an annotation user interface widget based on the determined annotation schema, the annotation user interface widget for receiving the annotation information for the first user interface widget; and
presenting the annotation user interface widget in response to at least one of an interaction between the first user interface widget and a user interface input device and satisfaction of an annotation rule associated with the first user interface widget.

7. The method of claim 6, comprising at least one of:
formatting the received annotation information according to a format corresponding to the determined annotation schema; and
validating the received annotation information based on the determined annotation schema.

8. The method of claim 1, wherein receiving annotation information comprises presenting an annotation user interface widget in response to at least one of an interaction between the first user interface widget and a user interface input device and satisfaction of an annotation rule associated with the first user interface widget, the annotation user interface widget for receiving the annotation information for the first user interface widget.

9. The method of claim 8, wherein presenting an annotation user interface widget comprises at least one of:
providing a first widget for receiving the annotation information for the first user interface widget;
presenting at least one attribute of the first user interface widget via the annotation user interface widget;
providing a second widget for automatically associating the annotation information with a widget included in the first user interface widget;
providing a third widget for associating the annotation information with a widget related to, but not included in, the first user interface widget; and
providing a fourth widget for associating user-defined help text with the first user interface widget.

10. The method of claim 1, wherein associating the annotation information with the first user interface widget comprises creating, in a data store, an attribute-annotation association that includes attribute information for matching the attribute of the first user interface widget and includes the annotation information for the first user interface widget to associate the annotation information with the first user interface widget.

11. The method of claim 1, wherein sharing the information comprises including at least a portion of the annotation information for the first user interface widget and an attribute of the first user interface widget in the shared information.

12. The method of claim 1, comprising including an identifier of an annotation schema associated with the attribute of the first user interface widget in the shared information, wherein the annotation schema defines at least one of a type and a format of the annotation information for the first user interface widget.

13. The method of claim 1, comprising:
receiving a request for annotation information for the first user interface widget, the request including an attribute of the first user interface widget;
accessing a data store including an attribute-annotation association that includes attribute information for matching an attribute of the first user interface widget and includes the annotation information;
determining annotation information to share with the second application based on the annotation information forming the attribute-annotation association when the attribute included in the request matches the attribute information forming the attribute-annotation association; and
sending a response including at least a portion of the determined annotation information.

14. The method of claim 1, wherein the information describing the association of the annotation information and the first user interface widget is automatically shared with the second application based on a subscription to annotation information associated with the first user interface widget.

15. The method of claim 1, wherein sharing the information comprises sending the information describing the association of the annotation information and the first user interface widget in at least one of a first message sent from a first device including the first application to a second device including the second application, a second message sent from the first device including the first application to a server, and a third message sent from the server to the second device including the second application.

16. The method of claim 1, wherein determining an attribute of and receiving annotation information for a first user interface widget comprises receiving the attribute and annotation information in at least one of a first message sent from a first device including the first application to a second device including the second application, a second message sent from the first device including the first application to a server, and a third message sent from the server to the second device including the second application.

17. A method for sharing user interface widget annotations, the method comprising:
receiving information including an attribute of a first user interface widget of a first application and annotation information associated with the first user interface widget via the attribute;
associating at least a portion of the annotation information with a second user interface widget of a second application, different from the first application; and
presenting the at least a portion of the annotation information associated with the second user interface widget of the second application.

18. The method of claim 17, comprising:
receiving an annotation output event related to the second user interface widget in response to at least one of an interaction between the second user interface widget and a user interface input device and satisfaction of an annotation rule associated with the second user interface widget; and
determining an attribute of the second user interface widget in response to receiving the annotation output event.

19. The method of claim 18, comprising:
accessing a data store including an attribute-annotation association that includes attribute information for matching an attribute of the first user interface widget and includes the annotation information; and
determining the at least a portion of the annotation information associated with the second user interface widget from the annotation information forming the attribute-annotation association when the attribute of the second user interface widget matches the attribute information forming the attribute-annotation association.

20. The method of claim 18, wherein associating at least a portion of the annotation information with a second user interface widget comprises creating, in a data store, an attribute-annotation association that includes attribute information for matching the attribute of the second user interface widget and includes the at least a portion of the annotation information to associate the at least a portion of the annotation information with the second user interface widget.

21. The method of claim 18, wherein presenting the at least a portion of the annotation information comprises generating a display of the at least a portion of the annotation information in response to receiving the annotation output event, the generated display presented in association with the second user interface widget based on a schema associated with the portion of the annotation information and based on a context of the annotation output event.

22. The method of claim 17, wherein receiving information comprises receiving the attribute and the annotation information for the first user interface widget in at least one of a first message sent from a first device including the first application to a second device including the second application, a second message sent from the first device including the first application to a server, and a third message sent from the server to the second device including the second application.

23. A device for sharing user interface widget annotations, the device comprising:
an annotation event monitor component configured to determine an attribute of a first user interface widget of a first application included on the device;
an annotation user interface component configured to receive annotation information for the first user interface widget;
a search/index manager component configured to associate the annotation information with the first user interface widget using the attribute; and
a share manager component configured to share information describing the association of the annotation information and the first user interface widget with a second application, different from the first application, the shared information enabling the second application to present the annotation information in association with a second user interface widget of the second application.

24. The device of claim 23, comprising an input hardware component configured to receive an annotation input event related to the first user interface widget in response to an interaction between the first user interface widget and a user interface input device

25. The device of claim 23, comprising an operating system component and a windowing subsystem component operatively coupled to the annotation event monitor component, wherein at least one of the operating system component, the windowing subsystem component, and the first application is configured to receive the annotation input event related to the first user interface widget in response to a satisfaction of an annotation rule associated with the first user interface widget, and the windowing subsystem component and the annotation event monitor component are configured to determine the attribute of the first user interface widget in response to receiving the annotation input event.

26. The device of claim 23, comprising a schema manager component configured to determine an annotation schema associated with the first user interface widget, the annotation schema defining at least one of a type and a format of the annotation information for the first user interface widget.

27. The device of claim 26, wherein the search/index manager component, operatively coupled to the schema manager component, is configured to access a data store including an attribute-schema association that includes attribute information for matching an attribute of the first user interface widget and includes an identifier of the annotation schema, and the schema manager component is configured to determine, in conjunction with the search/index manager component, the annotation schema having the identifier forming the attribute-schema association as the annotation schema associated with the first user interface widget when an attribute of the first user interface widget matches the attribute information forming the attribute-schema association.

28. The device of claim 27, wherein the attribute information forming the attribute-schema association includes at least one of a type of the first user interface widget, a name of the first user interface widget, a type of application the first user interface widget is associated with, a widget identifier, a format of the widget identifier, a type of widget the first user interface widget is embedded in or operates in conjunction with, and metadata associated with first user interface widget.

29. The device of claim 26, comprising:
an annotation user interface component configured to generate an annotation user interface widget based on the determined annotation schema, the annotation user interface widget for receiving the annotation information for the first user interface widget;
wherein the annotation user interface component is configured to present the annotation user interface widget in response to at least one of an interaction between the first user interface widget and a user interface input device and satisfaction of an annotation rule associated with the first user interface widget.

30. The device of claim 29, wherein the schema manager component is configured to at least one of format the received annotation information according to a format corresponding to the determined annotation schema and validate the received annotation information based on the determined annotation schema.

31. The device of claim 23, comprising an annotation user interface component configured to present an annotation user interface widget in response to at least one of an interaction between the first user interface widget and a user interface input device and satisfaction of an annotation rule associated with the first user interface widget, the annotation user interface widget for receiving the annotation information for the first user interface widget.

32. The device of claim 31, wherein the annotation user interface component is configured to at least one of:
provide a first widget for receiving the annotation information for the first user interface widget;
present at least one attribute of the first user interface widget via the annotation user interface widget;
provide a second widget for automatically associating the annotation information with a widget included in the first user interface widget;
provide a third widget for associating the annotation information with a widget related to, but not included in, the first user interface widget; and
provide a fourth widget for associating user-defined help text with the first user interface widget.

33. The device of claim 23, wherein the search/index manager component, operatively coupled to the share manager component, is configured to create, in a data store, an attribute-annotation association that includes attribute information for matching the attribute of the first user interface widget and includes the annotation information for the first user interface widget to associate the annotation information with the first user interface widget.

34. The device of claim 23, wherein the share manager component is configured to include at least a portion of the annotation information for the first user interface widget and an attribute of the first user interface widget in the shared information.

35. The device of claim 23, wherein the share manager component is configured to include an identifier of an annotation schema associated with the attribute of the first user interface widget in the shared information, wherein the annotation schema defines at least one of a type and a format of the annotation information for the first user interface widget.

36. The device of claim 23, wherein the share manager component is configured to receive a request for annotation information for the first user interface widget, the request including an attribute of the first user interface widget.

37. The device of claim 36, wherein the search/index manager component, operatively coupled to the share manager component, is configured to access a data store including an attribute-annotation association that includes attribute information for matching an attribute of the first user interface widget and includes the annotation information, and the share manager component is configured to determine, in conjunction with the search/index manager component, annotation information to share with the second application based on the annotation information forming the attribute-annotation association when the attribute included in the request matches the attribute information forming the attribute-annotation association and to send a response including at least a portion of the determined annotation information.

38. The device of claim 23, wherein the share manager component is configured to automatically share the information describing the association of the annotation information and the first user interface widget with the second application based on a subscription to annotation information associated with the first user interface widget.

39. The device of claim 23, comprising a communication subsystem component configured to send the information describing the association of the annotation information and the first user interface widget in at least one of a first message sent from the device to a second device including the second application and a second message sent from the device to a server.

40. The device of claim 23, wherein the device includes the second application.

41. The device of claim 40, comprising an input hardware component configured to receive an annotation output event related to the second user interface widget in response to an interaction between the second user interface widget and a user interface input device.

42. The device of claim 40, comprising an operating system component and a windowing subsystem component operatively coupled to the annotation event monitor component, wherein at least one of the operating system component, the windowing subsystem component, and the second application is configured to receive the annotation output event related to the second user interface widget in response to a satisfaction of an annotation rule associated with the second user interface widget, and the windowing subsystem component and the annotation event monitor component are configured to determine an attribute of the second user interface widget in response to receiving the annotation output event.

43. The device of claim 40, wherein the search index manager component is configured to access a data store including an attribute-annotation association that includes attribute information for matching an attribute of the first user interface widget and includes the annotation information and is configured to determine at least a portion of the annotation information associated with the second user interface widget from the annotation information forming the attribute-annotation association when the attribute of the second user interface widget matches the attribute information forming the attribute-annotation association.

44. The device of claim 40, wherein the search index manager component is configured to create, in a data store, an attribute-annotation association that includes attribute information for matching the attribute of the second user interface widget and includes the at least a portion of the annotation information to associate the at least a portion of the annotation information with the second user interface widget.

45. The device of claim 40, wherein the annotation user interface component is configured to generate a display of the at least a portion of the annotation information in response to receiving the annotation output event, the generated display presented in association with the second user interface widget using at least one of a windowing subsystem component and a graphics subsystem component of the device and based on a schema associated with the portion of the annotation information and based on a context of the annotation output event.

46. The device of claim 40, comprising a communication subsystem component configured to receive the attribute and the annotation information for the first user interface widget in at least one of a first message sent to the device from a second device including the first application and a second message sent to the device from a server.

47. A server for sharing user interface widget annotations, the server comprising:
an annotation event monitor component configured to receive information including an attribute of a first user interface widget of a first application and annotation information associated with the first user interface widget via the attribute;
a search/index manager component configured to associate at least a portion of the annotation information with a second user interface widget of a second application, different from the first application; and
a share manager component configured to share information describing the association of the annotation information and the first user interface widget with a second application, different from the first application, the shared information enabling the second application to present the annotation information in association with a second user interface widget of the second application.

48. The server of claim 47, comprising a schema manager component configured to determine an annotation schema associated with the first user interface widget, the annotation schema defining at least one of a type and a format of the annotation information for the first user interface widget.

49. The server of claim 48, wherein the search/index manager component, operatively coupled to the schema manager component, is configured to access a data store including an attribute-schema association that includes attribute information for matching an attribute of the first user interface widget and includes an identifier of the annotation schema, and the schema manager component is configured to determine, in conjunction with the search/index manager component, the annotation schema having the identifier forming the attribute-schema association as the annotation schema associated with the first user interface widget when an attribute of the first user interface widget matches the attribute information forming the attribute-schema association.

50. The server of claim 48, wherein the schema manager component is configured to at least one of format the received annotation information according to a format corresponding to the determined annotation schema and validate the received annotation information based on the determined annotation schema.

51. The server of claim 47, wherein the search/index manager component, operatively coupled to the share manager component, is configured to create, in a data store, an attribute-annotation association that includes attribute information for matching the attribute of the first user interface widget and includes the annotation information for the first user interface widget to associate the annotation information with the first user interface widget.

52. The server of claim 47, wherein the share manager component is configured to include at least a portion of the annotation information for the first user interface widget and an attribute of the first user interface widget in the shared information.

53. The server of claim 47, wherein the share manager component is configured to include an identifier of an annotation schema associated with the attribute of the first user interface widget in the shared information, wherein the annotation schema defines at least one of a type and a format of the annotation information for the first user interface widget.

54. The server of claim 47, wherein the share manager component is configured to receive a request for annotation information for the first user interface widget, the request including an attribute of the first user interface widget.

55. The server of claim 54, wherein the search/index manager component, operatively coupled to the share manager component, is configured to access a data store including an attribute-annotation association that includes attribute information for matching an attribute of the first user interface widget and includes the annotation information, and the share manager component is configured to determine, in conjunction with the search/index manager component, annotation information to share with the second application based on the annotation information forming the attribute-annotation association when the attribute included in the request matches the attribute information forming the attribute-annotation association and to send a response including at least a portion of the determined annotation information.

56. The server of claim 47, wherein the share manager component is configured to automatically share the information describing the association of the annotation information and the first user interface widget with the second application based on a subscription to annotation information associated with the first user interface widget.

57. The server of claim 47, comprising a communication subsystem component configured to send the information describing the association of the annotation information and the first user interface widget in a first message sent from the server to a device including the second application and configured to receive the attribute and the annotation information for the first user interface widget in a second message sent from a device including the first application to the server.

58. A computer readable medium containing a computer program, executable by a machine, for sharing user interface widget annotations, the computer program comprising executable instructions for:
determining an attribute of a first user interface widget of a first application;
receiving annotation information for the first user interface widget;
associating the annotation information with the first user interface widget using the attribute; and
sharing information describing the association of the annotation information and the first user interface widget with a second application, different from the first application, the shared information enabling the second application to present the annotation information in association with a second user interface widget of the second application.

59. A computer readable medium containing a computer program, executable by a machine, for sharing user interface widget annotations, the computer program comprising executable instructions for:
receiving information including an attribute of a first user interface widget of a first application and annotation information associated with the first user interface widget via the attribute;
associating at least a portion of the annotation information with a second user interface widget of a second application, different from the first application; and
presenting the at least a portion of the annotation information associated with the second user interface widget of the second application.

60. Apparatus for sharing user interface widget annotations, the apparatus comprising:
means for determining an attribute of a first user interface widget of a first application;
means for receiving annotation information for the first user interface widget;
means for associating the annotation information with the first user interface widget using the attribute; and
means for sharing information describing the association of the annotation information and the first user interface widget with a second application, different from the first application, the shared information enabling the second application to present the annotation information in association with a second user interface widget of the second application.

61. Apparatus for sharing user interface widget annotations, the apparatus comprising:
receiving information including an attribute of a first user interface widget of a first application and annotation information associated with the first user interface widget via the attribute;
associating at least a portion of the annotation information with a second user interface widget of a second application, different from the first application; and
presenting the at least a portion of the annotation information associated with the second user interface widget of the second application.
